(19) United States
(12) Patent Application Publication
(10) Pub. No.: US 2014/0242855 A1
(43) Pub. Date: Aug. 28, 2014

(54) DUST-PROOF COVER STRUCTURE FOR NETWORK CONNECTOR

(71) Applicant: KINSUN INDUSTRIES INC., Pingjhen City (TW)

(72) Inventors: CHING-NENG KAN, Taoyuan County (TW); CHANG-CHUN HUANG, Taoyuan County (TW)

(73) Assignee: KINSUN INDUSTRIES INC., Pingjhen City (TW)

(21) Appl. No.: 13/886,509

(22) Filed: May 3, 2013

(30) Foreign Application Priority Data
Feb. 22, 2013 (TW) 102203409

(51) Int. Cl. H01R 13/52

(52) U.S. Cl. CPC H01R 13/5213
USPC 439/892

(57) ABSTRACT

A dust-proof cover structure for network connectors, comprising: a frame, having a guide plate with a plurality of guide pins that is inclinedly arranged and at least one axial part mounted on a housing of the frame; a dust-proof cover, configured with at least one axial hole at a position corresponding to the at least one axial part; wherein, by mating the at least one axial part to its corresponding axial hole, the dust-proof cover is enabled to pivot about the axial part and rotate surrounding the housing of the frame for exposing the guide plate of the frame so as to allow a signal connector to plug into and lock onto the frame while enabling signal pins of the signal connector to connect electrically to the guide plate and simultaneously enabling the plug-in of the signal connector not to sit levelly in the frame, but by an incline angle.

### FIELD OF THE INVENTION

The present invention relates to a dust-proof cover structure for network connectors, and more particularly, to a network connector fitted with a dust-proof cover that the dust-proof cover is configured with a spring part for fixing signal connectors.

### BACKGROUND OF THE INVENTION

With rapid advance of technology, there are a variety of information technology (IT) products being developed that not only can bring great convenience to our daily life, but also can shorten the distance between people as the data transmission speed between those IT products is increasing with the rapid development of technology. However, the communication between IT products can only be enabled through the connection of connectors and cables, especially the network connectors that are commonly used for connecting IT products to Internet. Nowadays, there are already many types of network connectors available on the market, which are designed and adapted to be used as network signal interfaces for all kinds of IT products, including network interface cards, hubs, and IP routers, etc.

Please refer to FIG. 1 and FIG. 2A, which are respectively a schematic diagram showing a conventional network connector and a schematic diagram showing a conventional signal connector. As shown in FIG. 1, the conventional network connector 100 is primarily composed of a frame 102 and a plurality of pins 1004, in which the plural pins are disposed inclinedly by an angle with respect to a bottom surface of the frame. In addition, the frame 102 which can be made of plastics has two block panels 106 fitted on top of the frame 102. As shown in FIG. 2A, the conventional signal connector 200 that are generally made into a shape suitable to fit inside a socket 108 formed on the frame 102 of the conventional network connector 100, whereas the signal connector 200 has a plurality of metal strips 204 arranged thereon at positions corresponding respectively to the plural pins 104 of the frame 102. Moreover, there is a elastic fixing piece 206 arranged on top of the signal connector 200 and the fixing piece 206 is formed with a first end 208 and a second end 210 at opposite positions while allowing the first end 208 to be formed in a width larger than that of the second end 210. When the signal connector 200 is plugged into the network connector 100, the plural pins 104 of the network connector 100 are engaged respectively to the corresponding metal strips 204 of the signal connector 200 while allowing the first end 208 of the fixing piece 206 to slide through the bottom of the block panels 106 and then wedge on the rear of the block panels so as to fixedly securing the signal connector 200.

Please refer to FIG. 2B, which shows the plugging of a conventional signal connector into a conventional network connector. As shown in FIG. 2B, as the conventional network connector is generally adapted to mount itself fixedly on a vertical wall 212, the conventional signal connector 200 is plugging in a normal direction with respect to the vertical wall 212 into the network connector 100 while allowing a neighboring portion of signal cable extending out of the signal connector to be nailed to the vertical wall 212.

However, it is generally recognized that it is not a easy and convenient task to plug the conventional signal connector into the conventional network connector for the following reasons:
(1) As the signal connector must be positioned normal to the vertical wall so as to be plugged into the network connector, the communication cable extending out of the signal connector must be bended for allowing the same to be nailed to the vertical wall for fixing, and thereby, the signal communication through the bended cable may be adversely affected in a long run perspective.
(2) The network connector is vulnerable to the invasion of dust when there is no signal connector plugged therein, and thus the effectiveness of a dusty network connector in signal transmission can be severely affected.
(3) Since there is always a portion of communication cable being bended by a great angle when the signal connector is plugged into the network connector, the bended cable may suffer from elastic fatigue after a long period of bending, and thus the transmission efficiency of the cable may drop in consequence.

### SUMMARY OF THE INVENTION

In view of the disadvantages of prior art, the primary object of the present invention is to provide a dust-proof cover structure for network connectors, and more particularly, to a structurally simple dust-proof network connector that is configured with a dust-proof cover having a spring part for fixing signal connectors.

Another object of the invention is to provide a network connector formed with an internal inclined surface for allowing a signal connector to plug therein in an inclined angle defined by the internal inclined surface, thereby, enabling a communication cable to extend out from the signal connector smoothly with being bended too much by gravity so as to ensure good signal transmission quality.

To achieve the above objects, the present invention provides a dust-proof cover structure for network connectors, which comprises: a frame, having a guide plate with a plurality of guide pins that is inclinedly arranged therein and at least one axial part mounted on a housing of the frame; and a dust-proof cover, configured with at least one axial hole at a position corresponding to the at least one axial part; wherein, by mating the at least one axial part to its corresponding axial hole for coupling the dust-proof cover to the frame, the dust-proof cover is enabled to pivot about the axial hole and rotate surrounding the housing of the frame; and the dust-proof cover further comprises: a terminal; two locking blocks, each being formed with a locking surface; and a lead-angle surface, disposed at a position between the two locking blocks.

Operationally, the dust-proof cover can be rotated to a position for exposing the guide plate of the frame, and after a signal connector is being plugged into the frame, the signal pins of the signal connector will be connected electrically to the plural guide pins of the guide plate while allowing a fixing piece of the signal connector to inset and slide through the lead-angle surface and then enabling two locking elements of the fixing piece to respectively lock on to the two locking surfaces so as to fixedly secure the plugging of the signal connector to the frame. Moreover, since the guide plate is inclinedly arranged, the plug-in of the signal connector will not made the signal connector to sit levelly in the frame, but by an incline angle.

In an exemplary embodiment, the dust-proof further has two limiting blocks respectively disposed at positions outside the two locking blocks.

In an exemplary embodiment, each of the at least one axial hole is formed with a guiding groove.

In an exemplary embodiment, the frame further comprises: a stop, disposed on the housing of the frame at a position for enabling the same to engage with the terminal of the dust-proof cover when the dust-proof cover is enabled to pivot and rotate surrounding the frame so as to define an opening angle for the dust-proof cover.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic diagram showing a conventional network connector.

FIG. 2A is a schematic diagram showing a conventional signal connector.

FIG. 2B shows the plugging of a conventional signal connector into a conventional network connector.

FIG. 3 is a schematic diagram showing a dust-proof cover for network connectors that is positioned at a close state according to the present invention.

FIG. 4 is a schematic diagram showing a dust-proof cover for network connectors that is positioned at an open state according to the present invention.

FIG. 5 is an exposed diagram showing a dust-proof cover for network connectors according to the present invention.

FIG. 6A is a schematic diagram showing a network connector with a dust-proof cover structure that is being plugged into by a signal connector according to a first embodiment of the present invention.

FIG. 6B is a schematic diagram showing a network connector with a dust-proof cover structure that is being plugged into by a signal connector according to a second embodiment of the present invention.

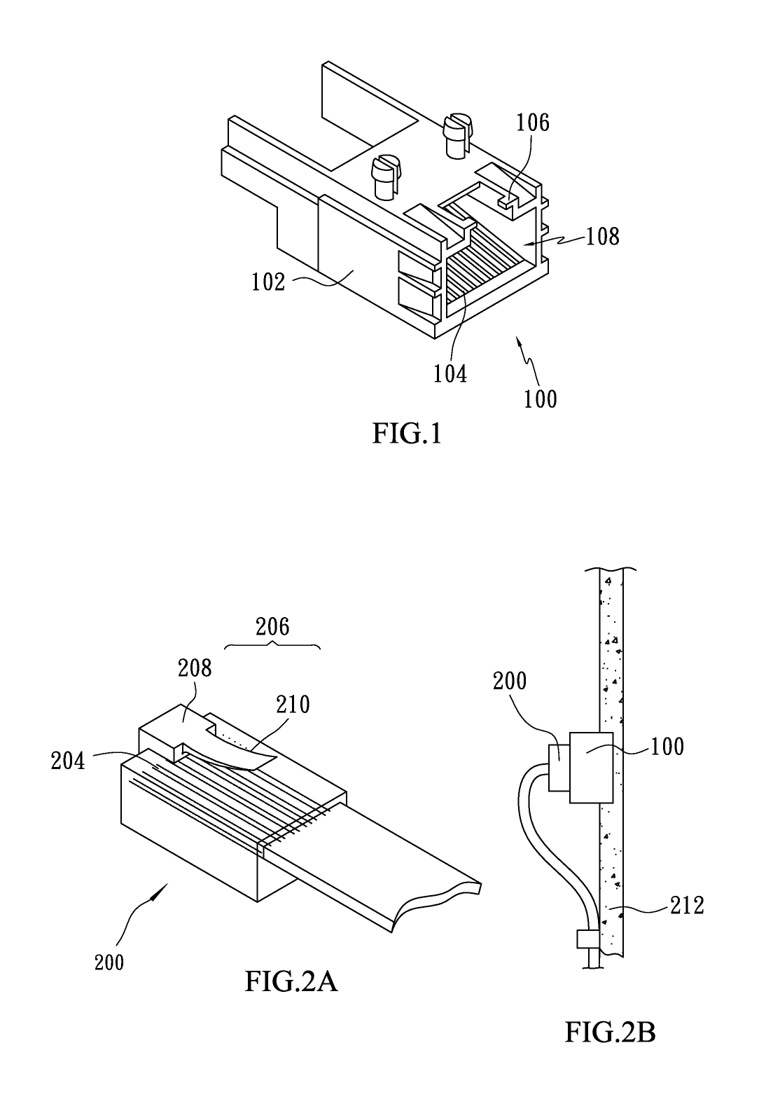

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

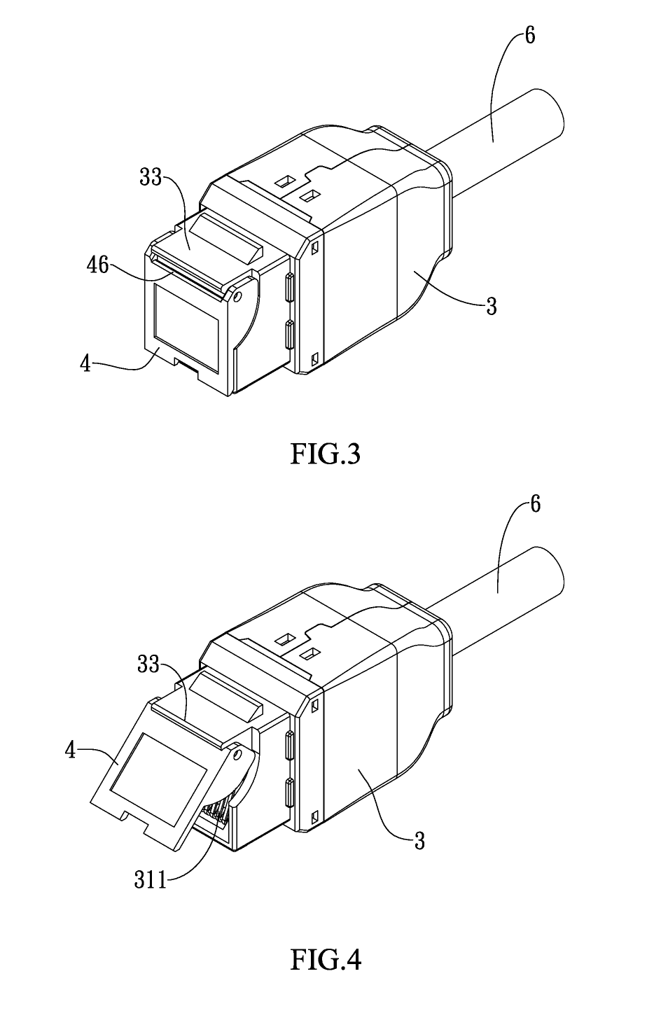

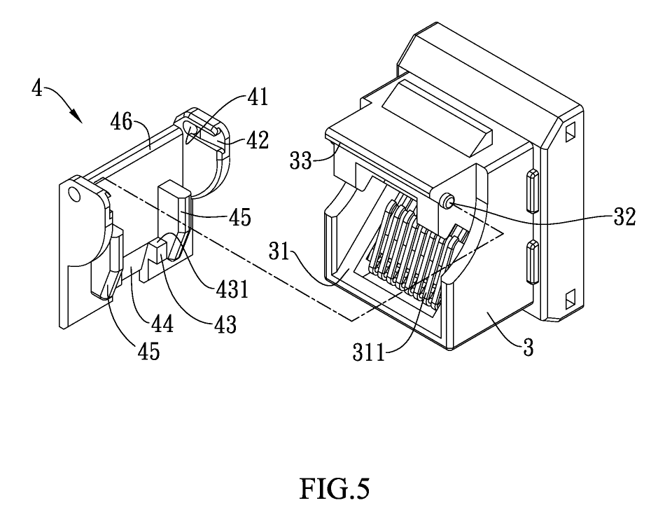

Please refer to FIG. 3, FIG. 4 and FIG. 5, which show a dust-proof cover structure for network connectors according to an embodiment of the invention. In this embodiment, the dust-proof cover structure comprises: a frame 3, having a guide plate 31 with a plurality of guide pins 311 that is inclinedly arranged therein while allowing the plural guide pins 311 to connected electrically to a cable 6 connecting to the frame 3, and at least one axial part 32 mounted on a housing of the frame 3; and a dust-proof cover 4, configured with at least one axial hole 41 at a position corresponding to the at least one axial part 32; wherein, each of the at least one axial hole 41 is formed with a guiding groove 42 whereas the guiding groove 42 is provided for guiding the corresponding axial part 32 to slide and inset into the corresponding axial hole 41; and by mating the at least one axial part 42 to its corresponding axial hole 41 for coupling the dust-proof cover 4 to the frame 3, the dust-proof cover 3 is enabled to pivot about the axial hole 41 and rotate surrounding the housing of the frame 3. Moreover, the dust-proof cover 4 further comprises: a terminal 46; two locking blocks 43, each being formed with a locking surface 431; and a lead-angle surface 44, disposed at a position between the two locking blocks 43.

In addition, in this embodiment, the dust-proof cover 4 further comprises: two limiting blocks 45 that are respectively disposed at positions outside the two locking blocks 43, and also the frame 3 further comprises: a stop 33, disposed on the housing of the frame 3 at a position for enabling the same to engage with the terminal 46 of the dust-proof cover when the dust-proof cover 4 is enabled to pivot and rotate surrounding the frame 3 so as to define an opening angle for the dust-proof cover 4.

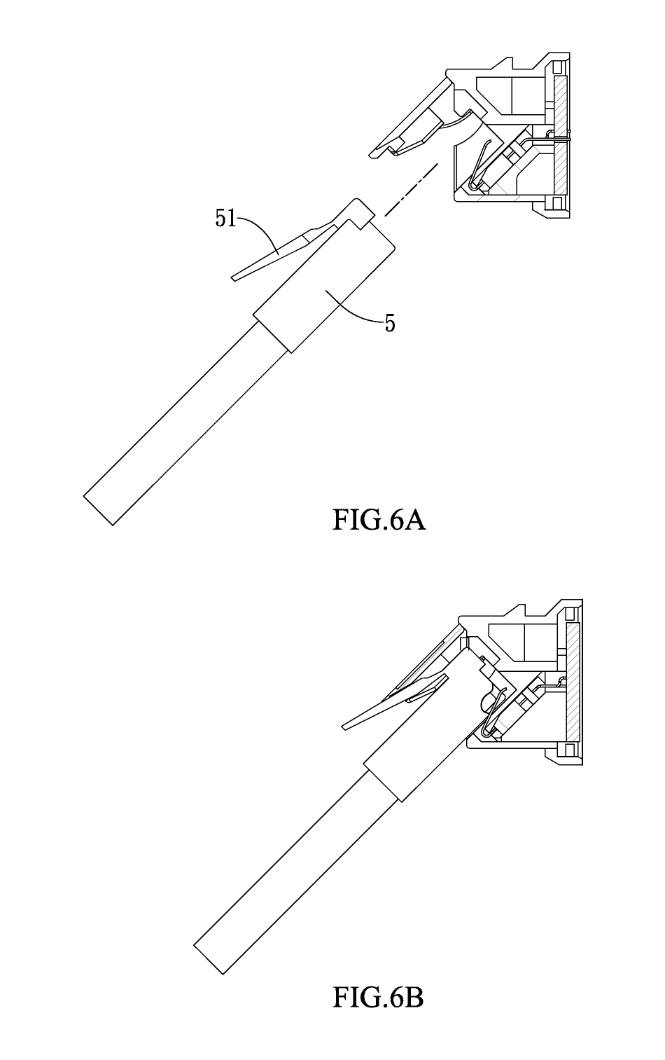

Please refer to FIG. 6A and FIG. 6B, which are two exemplary diagrams showing a network connector with a dust-proof cover structure that is being plugged into by a signal connector according to a first and a second embodiments of the present invention. As shown in FIG. 6A and FIG. 6B, the dust-proof cover 4 can be rotated to a position for exposing the guide plate 31 of the frame 3, and after a signal connector 5 is being plugged into the frame 3, the signal pins of the signal connector 5 will be connected electrically to the plural guide pins 311 of the guide plate 31 while allowing a fixing piece 51 of the signal connector 5 to inset and slide through the lead-angle surface 44 and then enabling two locking elements of the fixing piece 51 to respectively lock on to the two locking surfaces 431 so as to fixedly secure the plugging of the signal connector 5 to the frame 3, and since the guide plate 31 is inclinedly arranged, the plug-in of the signal connector 5 will not made the signal connector 5 to sit levelly in the frame, but by an incline angle.

To sum up, the network connector with the dust-proof cover of the present invention has the following advantages:
(1) Since the signal connector can be plugged into the network connector of the present invention in an incline angle, the communication cable extending out of the signal connector can fall naturally without being bended to much for allowing the same to be nailed to the vertical wall for fixing, and thereby, the portion of communication cable being bended may not suffer from elastic fatigue easily after a long period of bending, and thus lifespan of the communication cable is prolonged.
(2) By closing the dust-proof cover of the invention, the network connector will not be vulnerable to the invasion of dust when there is no signal connector plugged therein.
(3) The guide pins on the guide plate of the invention will not be bended too much, so that they will not suffer from elastic fatigue in a long run, and thus the effectiveness in signal transmission can be ensured.
(4) The manufacture cost of the network connectors with the dust-proof cover of the invention is cheap, so that it can be mass-produced with great commercial competitiveness.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A dust-proof cover structure for network connectors, comprising:
a frame, having a guide plate with a plurality of guide pins that is inclinedly arranged therein and at least one axial part mounted on a housing of the frame; and
a dust-proof cover, further comprises:
at least one axial hole at a position corresponding to the at least one axial part;
a terminal;
two locking blocks, each being formed with a locking surface; and
a lead-angle surface, disposed at a position between the two locking blocks.
wherein, by mating the at least one axial part to its corresponding axial hole for coupling the dust-proof cover to the frame, the dust-proof cover is enabled to pivot about the axial hole and rotate surrounding the housing of the frame; the dust-proof cover can be rotated to a position for exposing the guide plate of the frame, and after a signal connector is being plugged into the frame, the signal pins of the signal connector will be connected electrically to the plural guide pins of the guide plate while allowing a fixing piece of the signal connector to inset and slide through the lead-angle surface and then enabling two locking elements of the fixing piece to respectively lock on to the two locking surfaces so as to fixedly secure the plugging of the signal connector to the frame, and since the guide plate is inclinedly arranged, the plug-in of the signal connector will not made the signal connector to sit levelly in the frame, but by an incline angle.

2. The dust-proof cover structure of claim 1, the dust-proof cover further comprise:
two limiting blocks respectively disposed at positions outside the two locking blocks.

3. The dust-proof cover structure of claim 1, wherein each of the at least one axial hole is formed with a guiding groove.

4. The dust-proof cover structure of claim 1, wherein the frame further comprises: a stop, disposed on the housing of the frame at a position for enabling the same to engage with the terminal of the dust-proof cover when the dust-proof cover is enabled to pivot and rotate surrounding the frame so as to define an opening angle for the dust-proof cover.
